(19) United States
(12) Patent Application Publication
(10) Pub. No.: US 2014/0127946 A1
(43) Pub. Date: May 8, 2014

(54) RECEPTACLE CONNECTOR AND PLUG CONNECTOR

(71) Applicants: YAMAICHI ELECTRONICS CO., LTD., Tokyo (JP); YAMAICHI ELECTRONICS USA, INC., San Jose, CA (US)

(72) Inventors: Toshiyasu ITO, Tokyo (JP); Takeshi NISHIMURA, San Jose, CA (US); Osamu SHIMIZU, San Jose, CA (US)

(73) Assignees: YAMAICHI ELECTRONICS USA, INC., San Jose, CA (US); YAMAICHI ELECTRONICS CO., LTD., Tokyo (JP)

(21) Appl. No.: 13/672,609

(22) Filed: Nov. 8, 2012

(51) Int. Cl. H01R 24/28

(52) U.S. Cl. 439/629

(57) ABSTRACT

A receptacle connector includes: a housing which is made of a insulative resin, and which defines a housing space having an opening portion through which a connection target object is to be inserted; plural contacts which are made of a metal, and which include plural signal line contacts and plural ground contacts housed in the housing space so as to be arranged adjacent to each other; and plural conductive members which are made of a conductive resin, and which are disposed correspondingly with the plural ground contacts so that each of the plural conductive members is electrically connected to a corresponding one of the plural ground contacts.

### FIELD OF THE INVENTION

The present invention relates to a receptacle connector and a plug connector which are used as electric connectors.

### DESCRIPTION OF THE RELATED ART

A receptacle connector is used as one of electric connectors for connecting two circuit boards. Usually, such receptacle connector includes plural signal line contacts and plural ground contacts which are arranged parallel with each other. U.S. Pat. No. 8,177,564-B discloses a receptacle connector having a common contact which electrically connects plural ground contacts. The common contact is made of a conductive resin, and has a base portion which is distant from the plural ground contacts and plural contact projections which project from the base portion so as to be in contact with the respective ground contacts.

In the above receptacle connector, since the plural contact projections which are in contact with the respective ground contacts are integrated together by the base portion, the shape of the common contact needs to be changed every time the arrangement or the dimensions of the signal line contacts and the ground contacts are changed.

### SUMMARY OF THE INVENTION

An object of the present invention is to provide a receptacle connector and a plug connector in which plural conductive members can be arranged freely according to the arrangement or the dimensions of plural signal line contacts and plural ground contacts.

One aspect of the invention provides a receptacle connector used for an electrical connector for connecting two circuit boards, the receptacle connector including: a housing which is made of an insulative resin, and which defines a housing space having an opening portion through which a connection target object is to be inserted; plural contacts which are made of a metal, and which include plural signal line contacts and plural ground contacts housed in the housing space so as to be arranged adjacent to each other; and plural conductive members which are made of a conductive resin, and which are disposed correspondingly with the plural ground contacts so that each of the plural conductive members is electrically connected to a corresponding one of the plural ground contacts.

Another aspect of the invention provides a plug connector used for an electrical connector for connecting two circuit boards, the plug connector including: a blade to be inserted into a housing space of a receptacle connector which is a connection target object; plural signal line external contacts which are disposed on at least one surface of the blade correspondingly with plural signal line contacts of the receptacle connector; plural ground external contacts each of which is disposed adjacent to one of the plural signal line external contacts correspondingly with plural ground contacts of the receptacle connector; and plural plug-side conductive members which are disposed correspondingly with the plural ground external contacts so that each of the plural plug-side conductive members is electrically connected to a corresponding one of the plural ground external contacts.

### BRIEF DESCRIPTION OF THE DRAWINGS

FIG. 1 is a perspective view of a receptacle connector and a plug connector according to a first embodiment of the present invention in a state that they have not been connected to each other yet;

FIGS. 2A and 2B are a rear view and a bottom view, respectively, of the receptacle connector shown in FIG. 1;

FIG. 3 is a sectional view showing a state that the plug connector shown in FIG. 1 is inserted in the receptacle connector shown in FIG. 1;

FIG. 4 is a sectional view of the receptacle connector shown in FIG. 1;

FIG. 5 is a perspective view of plural conductive members provided in the receptacle connector shown in FIG. 1;

FIG. 6 is a perspective view of plural conductive members provided in a receptacle connector according to a second embodiment of the invention; and

FIG. 7A is a perspective view showing a state that the plural conductive members shown in FIG. 6 have not been integrated together by a metal plate yet, and FIG. 7B is a perspective view showing a state that the plural conductive members are integrated together by the metal plate.

### DETAILED DESCRIPTION OF EXEMPLARY EMBODIMENTS

### First Embodiment

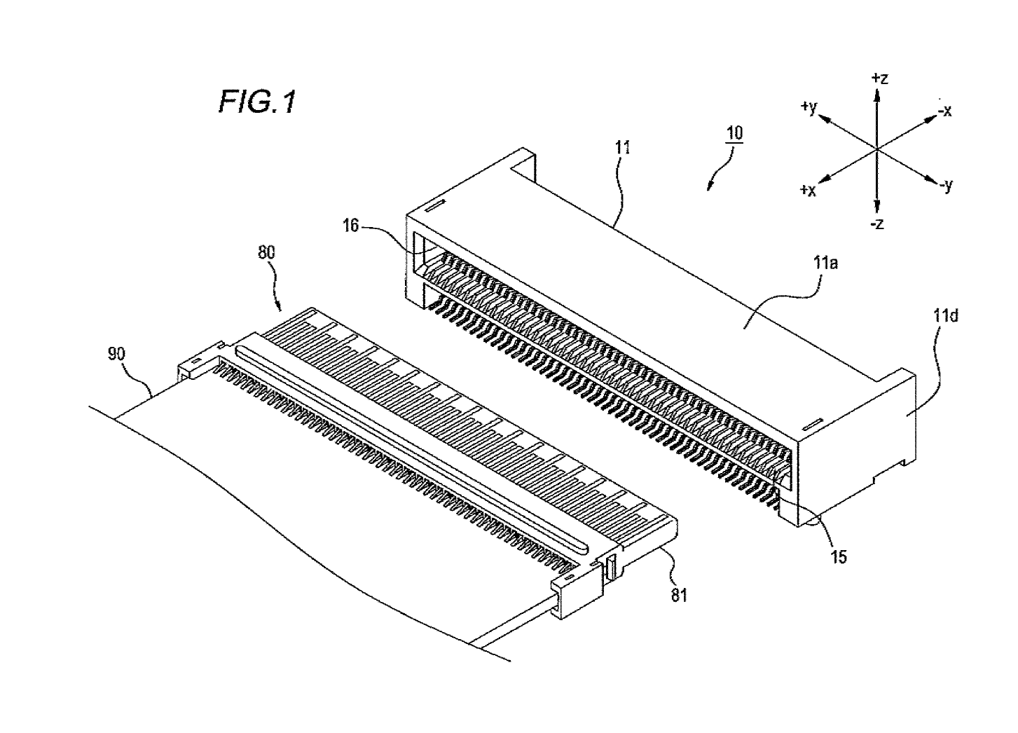

FIGS. 1-5 show a first embodiment of the present invention. In the description of the first embodiment, referring to FIG. 1, the +x direction and the −x direction are defined as the forward direction and the rearward direction, respectively, the +y direction and the −y direction are defined as the rightward direction and the leftward direction, respectively, and the +z direction and the −z direction are defined as the upward direction and the downward direction, respectively.

In the first embodiment, as shown in FIG. 1, electrical connectors for connecting two circuit boards are a receptacle connector 10 and a plug connector 80 which is to be inserted into the receptacle connector 10. For example, the plug connector 80 functions as a connection target object for the receptacle connector 10, and the receptacle connector 10 functions as a connection target object for the plug connector 80.

The receptacle connector 10 is attached to a circuit board (not shown) and the plug connector 80 to be inserted into the receptacle connector 10 is attached to another circuit board, that is, a printed wiring board 90. Instead of using the plug connector 80, (an external terminal portion of) the printed wiring board 90 may be inserted directly into the receptacle connector 10. In this case, the printed wiring board 90 functions as a connection target object for the receptacle connector 10.

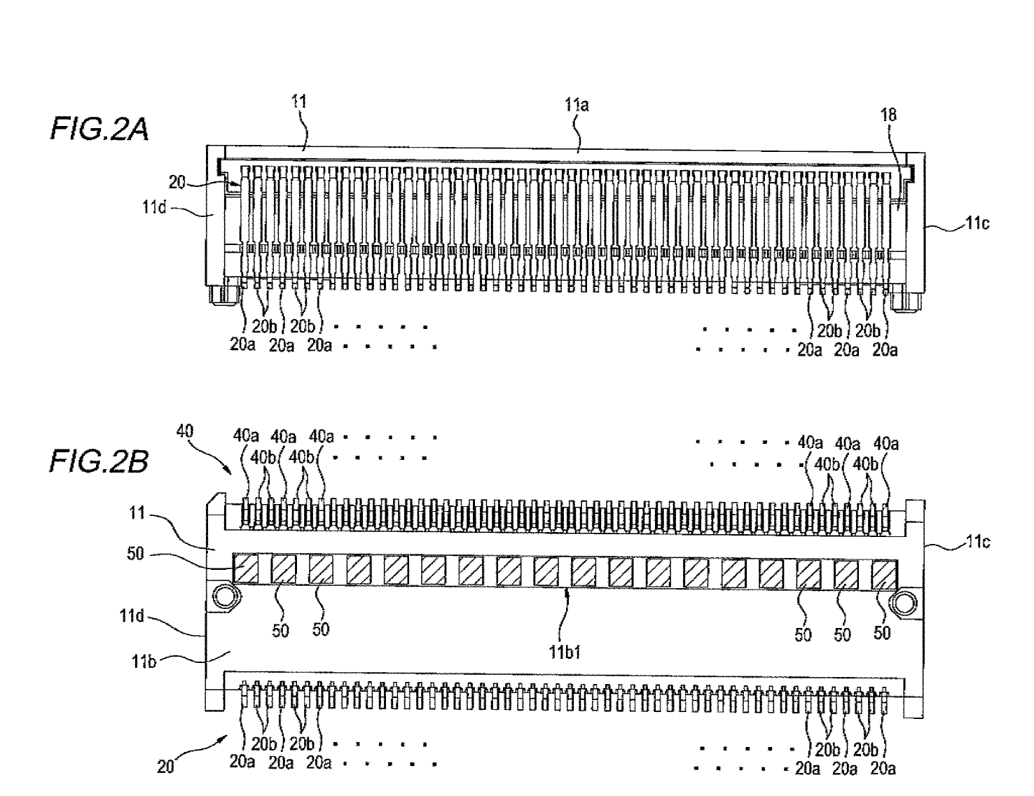

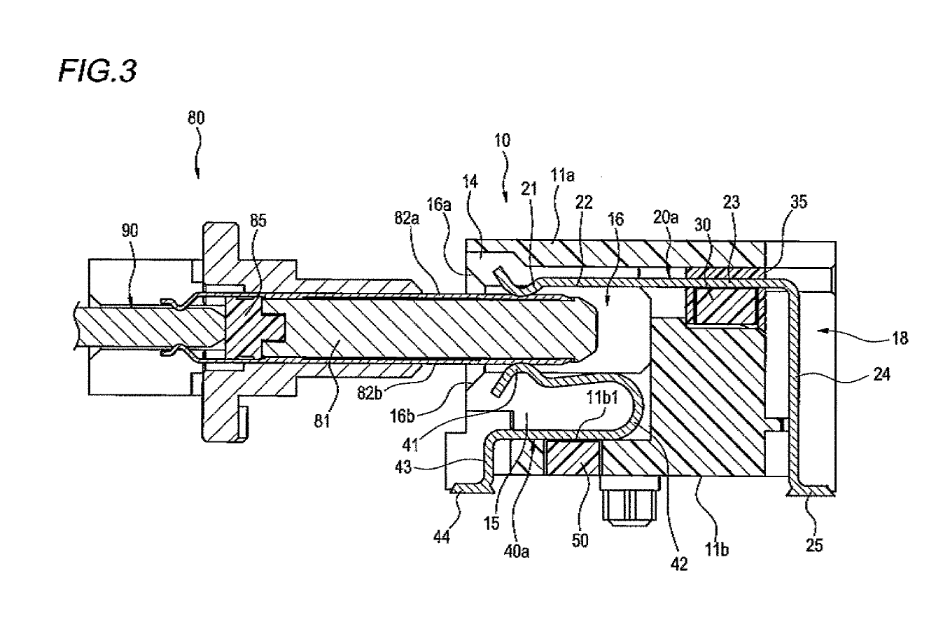

As shown in FIGS. 2A and 2B and FIG. 3, the receptacle connector 10 includes a housing 11, plural first row contacts 20, plural second row contacts 40, plural first conductive members 30 and plural second conductive members 50.

The housing 11 is made of an electrically insulative synthetic resin such as an LCP (liquid crystal polymer), and has an external form that is generally shaped like a rectangular parallelepiped. Specifically, the housing 11 has a top wall 11a, a bottom wall 11b, a left wall 11c and a right wall 11d.

In the housing 11, plural first slits 14 (see FIG. 3) are formed to extend in the front-rear direction and to thereby house parts of the respective plural first row contacts 20. On the front side of the housing 11, plural second slits 15 which house parts of the respective plural second row contacts 40 and a first housing space 16 which receives the plug connector 80 are formed. On the rear side of the housing 11, a second housing space 18 which houses the plural first row contacts 20 and a support member 35 for fixedly supporting the plural first row contacts 20 is formed. And, in the bottom wall 11b of the housing 11, a cavity 11b1 in which plural second conductive members 50 (described later) are inserted is formed.

The first housing space 16 is open to the front side and extends horizontally in the left-right direction of the receptacle connector 10, and is configured such that a blade 81 of the plug connector 80 can be inserted into it. As shown in FIG. 3, the vertical cross section of the first housing space 16 is similar to that of the plug connector 80. It is preferable that, to smoothly guide the plug connector 80 being inserted, front opening portions 16a and 16b be tapered such that their distance increases toward the front side.

The plural first slits 14 are located over the first housing space 16 and extend in the front-rear direction of the housing 11. The plural first slits 14 communicate the first housing space 16 on the front side, and communicate with the second housing space 18 on the rear side. The plural first slits 14 thus connect the first housing space 16 and the second housing space 18.

The plural second slits 15 which are disposed in the housing 11 on the front side are located under the first housing space 16, extend in the front-rear direction, and communicate with the first housing space 16 on the front side. The plural second slits 15 are formed such that the plural second row contacts 40 can be inserted into them from the front side when the receptacle connector 10 is assembled.

As shown in FIG. 3, the vertical cross section, taken along the front-rear direction, of the second housing space 18 which is formed in the housing 11 on the rear side is generally L-shaped so as to be similar to that of each of the plural first row contacts 20. The second housing space 18 is open to the rear side and the bottom side, and is connected to the front first housing space 16 via the plural first slits 14. The second housing space 18 extends horizontally in the left-right direction of the receptacle connector 10, and is formed such that the plural first row contacts 20 can be inserted into it from the rear side when the receptacle connector 10 is assembled.

In the embodiment, the plural first row contacts 20 include plural ground contacts (G) 20a and plural signal line contacts (S) 20b which are arranged adjacent to each other. Two adjoining ground contacts (G) 20a are located on the two respective sides of two signal line contacts (S) 20b for signal transmission, that is, so as to produce a G-S-S-G-S-S-G pattern. The plural first row contacts 20 which have approximately the same shape are manufactured by producing long and narrow plates by punching a metal thin plate and bending them into L-shaped plates.

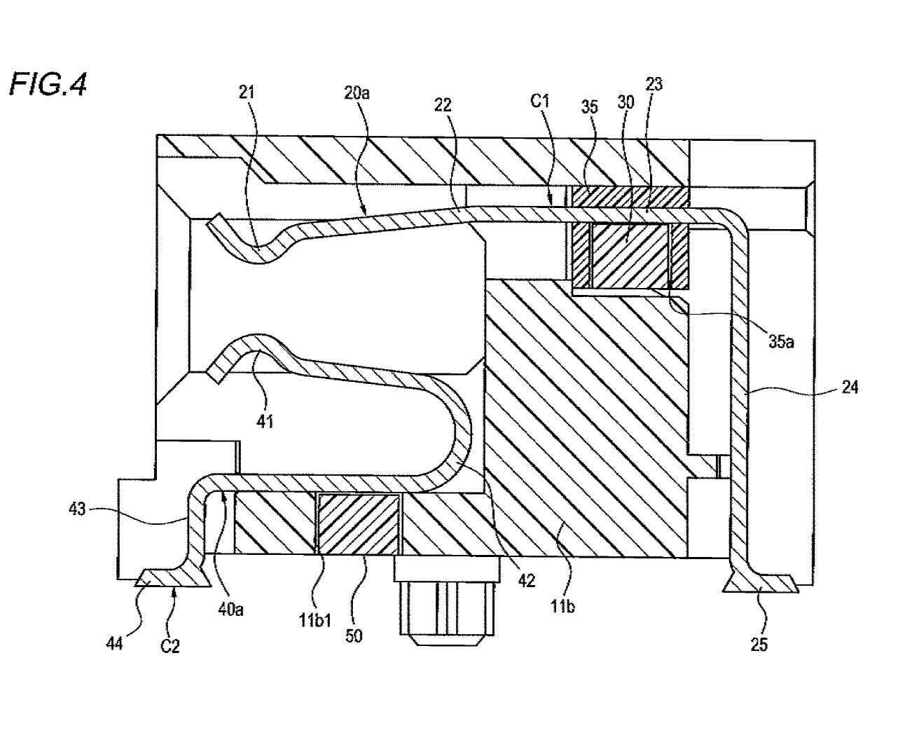

As shown in FIGS. 3 and 4, each of the plural first row contacts 20 includes a contact portion 21, an elastic deformation portion 22, a fixed portion 23, a vertical portion 24 and a terminal portion 25. When the plural first row contacts 20 have been incorporated in the housing 11, the contact portion 21, the elastic deformation portion 22 and the fixed portion 23 of each contact 20 are placed in the corresponding first slit 14 of the housing 11 at least partially. The vertical portion 24 and the terminal portion 25 of each contact 20 are placed in the second housing space 18.

The contact portion 21 of each of the plural first row contacts 20 is curved so as to be convex downward and thus projects downward from the corresponding first slit 14 into the first housing space 16. The contact portion 21 can come into contact with a corresponding first pad 82a (external contact) of the plug connector 80 at a desired contact pressure.

The elastic deformation portion 22 extends approximately horizontally and forward from the fixed portion 23 and is continuous with the contact portion 21. When deformed elastically, the elastic deformation portion 22 gives the contact portion 21 a desired contact pressure.

The fixed portion 23 extends horizontally and is continuous with the elastic deformation portion 22. The plural first row contacts 20 (actually their fixed portions 23) are integral with the support member 35 made of an insulative synthetic resin as a result of insert molding, whereby a first row contact assembly C1 is formed (see FIG. 4). The support member 35 has an opening portion 35a which is open to the bottom side. The fixed portions 23 of the plural ground contacts 20a of the plural first row contacts 20 are electrically connected to the plural first conductive members 30 (described later), respectively.

The vertical portion 24 connects the fixed portion 23 and the terminal portion 25. The vertical portion 24 is bent from the horizontal fixed portion 23 by approximately 90°, extends downward, and is continuous with the terminal portion 25.

The terminal portion 25, which is located below the vertical portion 24, is bent from the vertical portion 24 by approximately 90° and extends rearward. The terminal portion 25 can be connected to a corresponding external contact of the circuit board (not shown). More specifically, the terminal portions 25 are soldered to the external contacts of the circuit board, whereby the plural first row contacts 20 are electrically connected to an electric circuit of the circuit board.

Like the plural first row contacts 20, in the embodiment, the plural second row contacts 40 include plural ground contacts (G) 40a and plural signal line contacts (S) 40b which are arranged adjacent to each other in a G-S-S-G-S-S-G pattern. The plural first row contacts 20 are manufactured by producing long and narrow plates by punching a conductive metal thin plate and bending them into approximately U-shaped plates.

As shown in FIGS. 3 and 4, each of the plural second row contacts 40 includes a contact portion 41, an elastic deformation portion 42, a fixed portion 43 and a terminal portion 44. When incorporated in the housing 11, each of the plural second row contacts 40 is placed almost fully in the corresponding second slit 15 of the housing 11.

The contact portion 41 of each of the plural second row contacts 40 is curved so as to be convex upward and thus projects upward from the corresponding second slit 15 into the first housing space 16. The contact portion 41 can come into contact with a corresponding second pad 82b (external contact) of the plug connector 80 at a desired contact pressure.

The elastic deformation portion 42 extends continuously from the contact portion 41 to the fixed portion 43 so as to be U-shaped approximately. When deformed elastically, the elastic deformation portion 42 gives the contact portion 41 a desired contact pressure. The fixed portions 43 of the plural ground contacts 40a of the plural second row contacts 40 are electrically connected to the plural second conductive members 50 (described later), respectively.

The fixed portion 43 extends forward, is then bent by approximately 90° so as to extend downward, and connects to the terminal portion 44. The plural second row contacts 40 are integrated together through their fixed portions 43, whereby a second row contact assembly C2 is formed (see FIG. 4).

The terminal portion 44, which is located below the fixed portion 43, is bent from the fixed portion 43 by approximately 90° and extends forward. The terminal portion 44 can be connected to a corresponding external contact of the circuit board (not shown). More specifically, the terminal portions 44 are soldered to the external contacts of the circuit board, whereby the plural second row contacts 40 are electrically connected to the electric circuit of the circuit board.

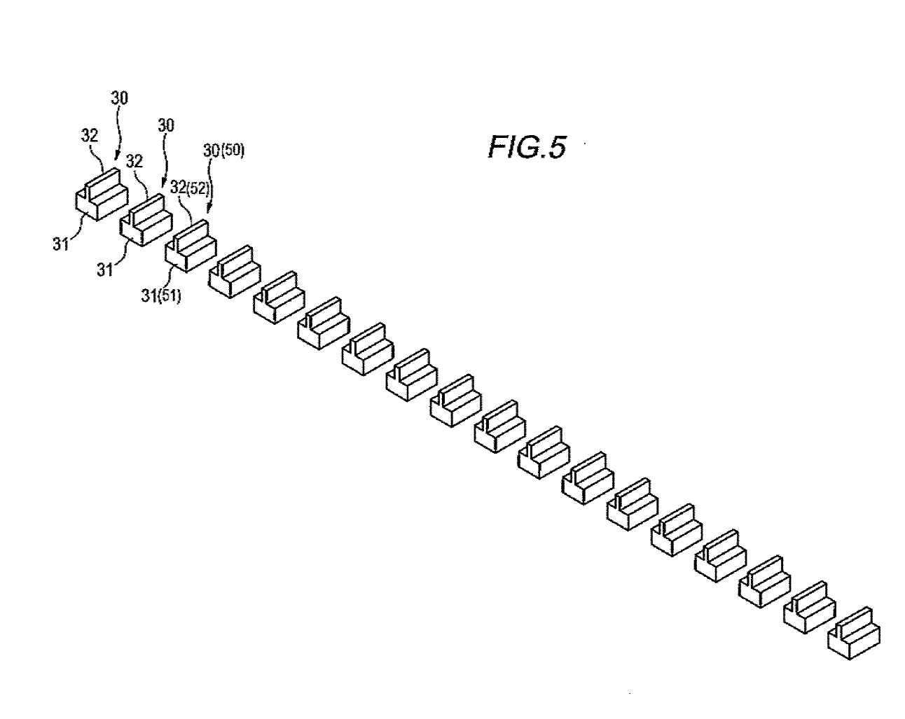

Next, the plural first conductive members 30 and the plural second conductive members 50 of the receptacle connector 10 according to the embodiment will be described with reference to FIGS. 4 and 5.

Usually, ground lines wired on a circuit board are connected to each other by, for example, a ground common plane which is formed inside the circuit board, and are thereby given the same voltage. However, if each of the plural contacts 20 and 40 were connected to the circuit board only at its one end inside the receptacle connector 10, the ground contacts 20a and 40a would be disposed so as to be distant from the ground common plane which is formed inside the circuit board, whereby the ground contacts 20a and 40a would have different voltages which are different from the voltage of the ground lines on the circuit board. This would lower the shield effect of each of the ground contacts 20a and 40a for a high-frequency signal having frequency components of several gigahertz. As a result, crosstalk between adjoining signal line contacts 20b or 40b or signal line contacts 20b or 40b between which one ground contact 20a or 40a is interposed might be increased.

In the embodiment, to equalize the voltages of the plural ground contacts 20a of the plural first row contacts 20, the plural first conductive members 30 are provided correspondingly with the plural ground contacts 20a. Furthermore, to equalize the voltages of the plural ground contacts 40a of the plural second row contacts 40, the plural second conductive members 50 are provided correspondingly with the plural ground contacts 40a.

First, the plural first conductive members 30 will be described. The plural first conductive members 30, which are made of a conductive resin, are members for electrically connecting the plural ground contacts 20a of the plural first row contacts 20. As shown in FIG. 4, each of the plural first conductive members 30 is fixed to the opening portion 35a which is formed in the support member 35 for integrating the plural first row contacts 20 together, as a result of insertion into the opening portion 35a from below.

The plural first conductive members 30 are formed by injection-molding a conductive resin in which fine particles or fibers of a conductive material such as carbon or nickel are mixed into a synthetic resin such as LCP (liquid crystal polymer) or PPS (polyphenylene sulfide).

As shown in FIG. 5, each of the plural first conductive members 30 has a base portion 31 and a projection 32 which projects from the base portion 31 so as to be electrically connected to the corresponding ground contact 20a.

Each of the plural first conductive members 30 is held by the inner side surfaces of the opening portion 35a as a result of insertion into the opening portion 35a from below (press fitting). Each of the plural first conductive members 30 can be inserted into the opening portion 35a to such a position that its projection 32 contacts the corresponding ground contact 20a. Therefore, the height positions of the first conductive members 30 can be adjusted according to the heights of the respective ground contacts 20a.

Thus, the plural first conductive members 30 are electrically connected to the respective ground contact 20a of the plural first row contacts 20. Since the plural first conductive members 30 are made of a conductive resin, adjoining first conductive members 30 are also connected to each other electrically. Therefore, according to the embodiment, the plural ground contact 20a which are electrically connected to the respective first conductive members 30 can be kept at the same voltage.

Next, the plural second conductive members 50 will be described. The plural second conductive members 50, which are made of a conductive resin, are members for electrically connecting the plural ground contacts 40a of the plural second row contacts 40. Like the plural first conductive members 30, the plural second conductive members 50 are made of a conductive resin in which fine particles or fibers of a conductive material such as carbon or nickel are mixed into a synthetic resin such as LCP or PPS.

Like each of the plural first conductive members 30 shown in FIG. 5, each of the plural second conductive members 50 has a base portion 51 and a projection 52 which projects from the base portion 51 so as to be electrically connected to the corresponding ground contact 40a.

As shown in FIG. 4, like each of the plural first conductive members 30, each of the plural second conductive members 50 is held by the inner side surfaces of the cavity 11b1 which is formed in the bottom wall 11b of the housing 11 as a result of insertion into the cavity 11b1 from below (press fitting). Each of the plural second conductive members 50 can be inserted into the cavity 11b1 to such a position that its projection contacts the corresponding ground contact 40a. Therefore, the height positions of the second conductive member 50 can be adjusted individually according to the heights of the respective ground contacts 40a.

Thus, the plural second conductive members 50 are electrically connected to the respective ground contact 40a of the plural second row contacts 40. Since the plural first conductive members 50 are made of a conductive resin, adjoining second conductive members 50 are also connected to each other electrically. Therefore, according to the embodiment, the plural ground contact 40a which are electrically connected to the respective second conductive members 50 can be kept at the same voltage.

Next, the plug connector 80 according to the embodiment will be described with reference to FIG. 3. The plural first pads 82a and the plural second pads 82b are provided on the top surface and the bottom surface of the blade 81 of the plug connector 80, respectively. The plural first pads 82a and the plural second pads 82b are conductive metal thin plates. When the blade 81 is inserted into the first housing space 16 of the receptacle connector 10, the plural first pads 82a and the plural second pads 82b (external contacts) come into contact with the plural contacts 20 of the upper first row contact assembly C1 and the plural contacts 40 of the lower second row contact assembly C2 of the receptacle connector 10, respectively.

Each of the set of plural first pads 82a and the set of plural second pads 82b of the plug connector 80 include plural signal line external contacts (S) and plural ground external contacts (G). The plural signal line external contacts (S) and the plural ground external contacts (G) are arranged in a G-S-S-G-S-S-G pattern, correspondingly with the plural contacts 20 or 40 of the receptacle connector 10. Therefore, when the blade 81 is inserted into the first housing space 16 of the receptacle connector 10, the printed wiring board 90 to which the plug connector 80 is attached is electrically connected to the circuit board (not shown) to which the receptacle connector 10 is attached. As a result, signals can be exchanged between the circuit board and the printed wiring board 90 by high-speed transmission.

As shown in FIG. 3, a plug-side conductive member 85 is disposed between the first pads 82a and the second pads 82b. The plug-side conductive member 85 is made of a conductive resin and is in contact with the plural ground external contacts. Therefore, the plug-side conductive member 85 electrically can connect all the ground external contacts provided on the top and bottom surfaces of the blade 81 and keep all the ground external contacts at the same voltage.

Next, how the first row contact assembly C1 and the second row contact assembly C2 are incorporated into the receptacle connector 10 according to the embodiment will be described briefly.

First, the plural first row contacts 20 are integrated with the support member 35 by insert molding, whereby a first row contact assembly C1 is formed. Then, the plural first conductive members 30 are inserted into the opening portion 35a of the support member 35 from below so that their projections 32 are located at positions corresponding to the ground contacts 20a, whereby the projections 32 of the inserted plural first conductive members 30 come into physical contact with the corresponding ground contacts 20a. Therefore, the height positions of the plural first conductive members 30 can be adjusted individually in the opening portion 35a of the support member 35.

Then, the first row contact assembly C1 incorporating the plural first conductive members 30 is inserted into the second housing space 18 of the housing 11 from behind. At this time, the contact portions 21 and the elastic deformation portions 22 of the plural first row contacts 20 are disposed in the corresponding first slits 14 and the support member 35 is disposed at the prescribed position in the second housing space 18. The first row contact assembly C1 is thus supported by and fixed to the receptacle connector 10.

Then, the second row contact assembly C2 is inserted into the first housing space 16 from the from side. At this time, the plural contacts 40 of the second row contact assembly C2 are disposed in the corresponding second slits 15, whereby the second row contact assembly C2 is supported by and fixed to the receptacle connector 10.

Subsequently, the plural second conductive members 50 are inserted, from below, into the cavity 11b1 which is formed in the bottom wall 11b of the housing 11 so that the projections 52 of the plural second conductive members 50 are disposed at the positions corresponding to the ground contacts 40a, whereby the projections 52 of the inserted plural second conductive members 50 come into physical contact with the corresponding ground contacts 40a. Therefore, the height positions of the plural second conductive members 50 can be adjusted individually in the cavity 11b1 of the bottom wall 11b. The assembling of the receptacle connector 10 according to the embodiment is thus completed.

As described above, in the receptacle connector 10 according to the embodiment, the plural first conductive members 30 which are made of a conductive resin are provided correspondingly with the plural ground contacts 20a and the plural second conductive members 50 which are made of a conductive resin are provided correspondingly with the plural ground contacts 40a. Therefore, the plural first conductive members 30 and the plural second conductive members 50 can be arranged freely according to the arrangement or the dimensions of the plural ground contacts 20a and the plural ground contacts 40a. Thus, the flexibility of designing of the receptacle connector 10 can be increased.

Furthermore, in the receptacle connector 10 according to the embodiment, the first conductive members 30 and the second conductive members 50 are both divisional members. Therefore, the amount of an expensive conductive resin to be used can be made smaller, and the cost can be made lower than in the conventional case that the single conductive member is provided for either of the plural ground contacts 20a and the plural ground contacts 40a.

In receptacle connectors, the height positions of the plural ground contacts which are in contact with the contact projections that project from the conductive member may vary slightly at their contact positions. In such an event, if as in the conventional case the plural contact projections are integral with the base portions of the conductive member as a result of integral molding, physical contact may not be secured between part of the plural ground contacts and the corresponding contact projections.

In contrast, in the receptacle connector 10 according to the embodiment, the first conductive members 30 and the second conductive members 50 are both divisional members the number of which is equal to the number of ground contacts 20a or 40a. As a result, the projections 32 of the plural first conductive members 30 or the projections 52 of the plural second conductive members 50 are inserted into the opening portion 35a or the cavity 11b1 to such positions as to come into contact with the respective ground contacts 20a or 40a, whereby the height positions of the plural first conductive members 30 or the plural second conductive members 50 can be adjusted individually. Therefore, even where the ground contacts 20a or 40a have some height variation, physical contact between the projections 32 of the plural first conductive members 30 and the ground contacts 20a or between the projections 52 of the plural second conductive members 50 can be secured, whereby the ground contacts 20a or 40a can always be kept at the same voltage. As a result, the crosstalk between signal lines can be reduced, and noise emission can be prevented.

### Second Embodiment

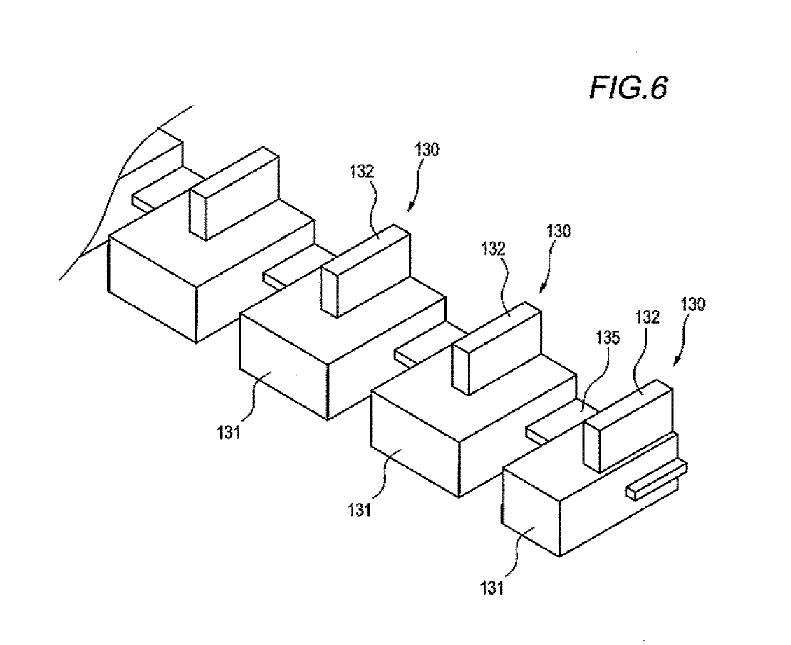

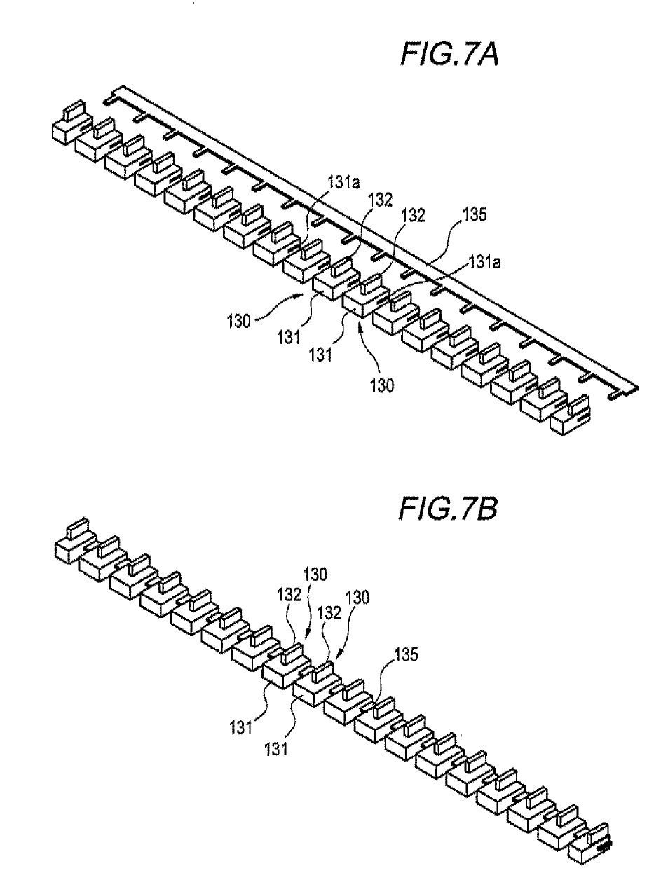

Next, a second embodiment of the invention will be described with reference to FIG. 6 and FIGS. 7A and 7B.

As shown in FIG. 6, in the second embodiment, each of plural first conductive members 130 of a receptacle connector is made of a conductive resin and has a base portion 131 and a projection 132 which projects from the base portion 131 so as to be electrically connected to the corresponding ground contact 20a.

As shown in FIGS. 7A and 7B, the plural first conductive members 130 are connected to each other, that is, integrated together, when a long and thin metal plate 135 is inserted into slits 131a which are formed in back-side portions of the base portions 131, respectively.

Since the plural first conductive members 130 are integrated together by the thin metal plate 135, the plural first conductive members 130 have such flexibility as to be able to absorb a height variation of the ground contacts 20a. Therefore, when the plural first conductive members 130 are inserted into the opening portion 35a of the support member 35, the projections 132 come into contact with the corresponding ground contacts 20a, whereby the height positions of the plural first conductive members 130 can be adjusted individually according to the heights of the respective ground contacts 20a.

With the above structure, physical contact between the ground contacts 20a and the projections 132 of the plural first conductive members 130 can always be secured. As a result, as in the first embodiment, advantages are obtained that the reduction of the shield effect is prevented and the crosstalk is reduced.

Since the plural first conductive members 130 are connected to each other by the metal plate 135 and thereby integrated together, they can be handled more easily than the plural first conductive members 30 used in the first embodiment.

Like the plural first conductive members 130, plural second conductive members which are electrically connected to the respective ground contacts 40a may be connected to each other by a thin metal plate and thereby integrated together.

Although the invention has been described above in detail by referring to the particular embodiments, it is apparent to those skilled in the art that various changes and modifications are possible without departing from the spirit and scope of the invention. And the numbers, positions, shapes, etc. of the above-described constituent members are not limited to those described in the embodiments and can be changed to ones that are proper in practicing the invention.

For example, although in the first and second embodiments the projections 32 or 132 of the plural first conductive members 30 or 130 are in physical contact with the corresponding ground contacts 20a, the invention is not limited thereto. For example, the projections 32 or 132 may be disposed so as to have prescribed gaps between themselves and the corresponding ground contacts 20a. Where the projections 32 or 132 are in physical contact with the corresponding ground contacts 20a, the ground contacts 20a are DC-connected to each other. This may cause trouble that the ground contacts 20a interfere with each other because of low resistance. In contrast, where the prescribed gaps are formed between the projections 32 or 132 and the corresponding ground contacts 20a, DC current is shut off and the ground contacts 20a can be electrically connected to each other only in a high-frequency range.

The feature that the plural ground contacts 20a of the plural first row contacts 20 are electrically connected to each other only in a high-frequency range results in an advantage that the plural ground contacts 20a are given the same voltage. Furthermore, the crosstalk can be reduced further while interference between the ground contacts 20a is prevented.

Likewise, the projections 52 of the plural second conductive members 50 may also be disposed so as to have prescribed gaps between themselves and the corresponding ground contacts 40a of the plural second row contacts 40.

The plug connector 80 may include plug-side conductive members which are similar to the first conductive members 30 or 130 of the receptacle connector according to the first or second embodiment. For example, like the first conductive members 30 of the receptacle connector 10 according to the first embodiment, divisional plug-side conductive members may be provided in the same number as the number of ground external contacts, each divisional plug-side conductive member having a plug-side base portion and a plug-side projection which projects from the plug-side base portion. In this case, when the plural plug-side conductive members are incorporated into the plug connector 80, the plug-side projections come into physical contact with the corresponding ground external contacts, whereby the height positions of the respective plug-side conductive members can be adjusted.

With this structure, physical contact can be secured between the plural ground external contacts of the plug connector 80 and the plug-side projections, whereby the ground external contacts can always be kept at the same voltage. As a result, also in the plug connector 80, the crosstalk between signal lines can be reduced, and noise emission can be prevented.

In addition, the plug-side projections may be disposed so as to have prescribed gaps between themselves and the corresponding ground external contacts.

In the above embodiments, the first row contact assembly C1 is formed by integrating the plural first row contacts 20 with the support member 35 by insert molding and inserting the thus-formed first row contact assembly C1 into the second housing space 18 of the housing 11. However, the invention is not limited thereto. For example, a press-fitting portion may be provided to each of the first slits 14 so as to hold a corresponding one of the plural first row contacts 20 by the inner wall surfaces of the press-fitting portion.

Although the first row contact assembly C1 and the second row contact assembly C2 which are separate from each other are exemplified in the above embodiments, they may be combined into a single assembly. For example, the first row contact assembly C1 and the contact assembly C2 may be bonded to each other in the top-bottom direction with adhesive, for example. Or the first row contact assembly C1 and the contact assembly C2 may be integrated with each other by insert molding.

Integrating the first row contact assembly C1 and the contact assembly C2 with each other can make the assembling easier and more reliable and decrease the number of manufacturing (assembling) steps.

In the above embodiment, the plural first conductive members 30 or 130 and the plural second conductive members 50 are inserted into the opening portion 35a which is formed in the support member 30 and the cavity 11b1 which is formed in the bottom wall 11b, respectively, from below. However, the plural first conductive members 30 or 130 and the plural second conductive members 50 may be integrated together with the support member 35 and the housing 11, respectively, by insert molding. In this case, the plural first conductive members 30 or 130 and the plural second conductive members 50 can be precisely disposed with respect to the plural ground contacts 20a and the plural ground contacts 40a which are fixedly supported by the support member 35 and the housing 11, respectively.

In the above embodiment, the number of the plural first conductive members 30 or 130 and the number of the plural second conductive members 50 are the same with the number of the plural ground contacts 20a and the number of the plural ground contacts 40a, respectively. However, the number of the conductive members may be different from the number of the ground contacts. Specifically, the number of the conductive members may be smaller than the number of the ground contacts if at least one of the ground contacts is not necessary to be provided with the conductive member.

While the present inventive concept has been shown and described with reference to certain exemplary embodiments thereof, it will be understood by those skilled in the art that various changes in form and details may be made therein without departing from the spirit and scope of the invention as defined by the appended claims.

1. A receptacle connector used for an electrical connector for connecting two circuit boards, the receptacle connector comprising:
a housing which is made of an insulative resin, and which defines a housing space having an opening portion through which a connection target object is to be inserted;
plural contacts which are made of a metal, and which comprise plural signal line contacts and plural ground contacts housed in the housing space so as to be arranged adjacent to each other; and
plural conductive members which are made of a conductive resin, and which are disposed correspondingly with the plural ground contacts so that each of the plural conductive members is electrically connected to a corresponding one of the plural ground contacts.

2. The receptacle connector according to claim 1,
wherein at least part of the plural conductive members are connected to each other by at least one metal plate.

3. The receptacle connector according to claim 1,
wherein the plural conductive members comprise:
base portions which are disposed correspondingly with the plural ground contacts; and
projections which project from the respective base portions toward the corresponding ground contacts so as to be electrically connected thereto.

4. The receptacle connector according to claim 3,
wherein the projections are in physical contact with the corresponding ground contacts, respectively.

5. The receptacle connector according to claim 3,
wherein the projections have prescribed gaps between themselves and the corresponding ground contacts, respectively.

6. The receptacle connector according to claim 2,
wherein the plural conductive members comprise:
base portions which are disposed correspondingly with the plural ground contacts; and
projections which project from the respective base portions toward the corresponding ground contacts so as to be electrically connected thereto.

7. The receptacle connector according to claim 6,
wherein the projections are in physical contact with the corresponding ground contacts, respectively.

8. The receptacle connector according to claim 6,
wherein the projections have prescribed gaps between themselves and the corresponding ground contacts, respectively.

9. A plug connector used for an electrical connector for connecting two circuit boards, the plug connector comprising:
a blade to be inserted into a housing space of a receptacle connector which is a connection target object;
plural signal line external contacts which are disposed on at least one surface of the blade correspondingly with plural signal line contacts of the receptacle connector;
plural ground external contacts each of which is disposed adjacent to one of the plural signal line external contacts correspondingly with plural ground contacts of the receptacle connector; and
plural plug-side conductive members which are disposed correspondingly with the plural ground external contacts so that each of the plural plug-side conductive members is electrically connected to a corresponding one of the plural ground external contacts.

10. The plug connector according to claim 9,
wherein at least part of the plural plug-side conductive members are connected to each other by at least one metal plate.

11. The plug connector according to claim 9,
wherein the plural plug-side conductive members comprise:
plug-side base portions which are disposed correspondingly with the plural ground external contacts; and
plug-side projections which project from the respective plug-side base portions toward the corresponding ground external contacts so as to be electrically connected thereto.

12. The plug connector according to claim 11,
wherein the plug-side projections are in physical contact with the corresponding ground external contacts, respectively.

13. The plug connector according to claim 11,
wherein the plug-side projections have prescribed gaps between themselves and the corresponding ground external contacts, respectively.

14. The plug connector according to claim 10,
wherein the plural plug-side conductive members comprise:
plug-side base portions which are disposed correspondingly with the plural ground external contacts; and
plug-side projections which project from the respective plug-side base portions toward the corresponding ground external contacts so as to be electrically connected thereto.

15. The plug connector according to claim 14,
wherein the plug-side projections are in physical contact with the corresponding ground external contacts, respectively.

16. The plug connector according to claim 14,
wherein the plug-side projections have prescribed gaps between themselves and the corresponding ground external contacts, respectively.
